(19) United States
(12) Patent Application Publication
(10) Pub. No.: US 2026/0058175 A1
(43) Pub. Date: Feb. 26, 2026

(54) SELF-WAKE-UP CONTROL METHOD, CONTROL UNIT, COMPUTER PROGRAM PRODUCT, AND STORAGE MEDIUM FOR A FUEL CELL SYSTEM AFTER SHUTDOWN

(71) Applicants: Robert Bosch GmbH, Stuttgart (DE); Bosch Hydrogen Powertrain Systems (Chongqing) Co., Ltd., Chongping (CN)

(72) Inventors: Pengcheng Liu, Chongqing (CN); Changjiang Li, Chongqing (CN); Guopeng Yang, Chongqing (CN)

(21) Appl. No.: 19/306,045

(22) Filed: Aug. 21, 2025

(30) Foreign Application Priority Data
Aug. 23, 2024 (CN) 2024 1117 1703.0

(51) Int. Cl. H01M 8/04223; H01M 8/04007; H01M 8/04225; H01M 8/04302; H01M 8/0432

(52) U.S. Cl. CPC H01M 8/04253; H01M 8/04007; H01M 8/04225; H01M 8/04231; H01M 8/04302; H01M 8/0432; H01M 8/04358; H01M 2250/20

(57) ABSTRACT

A self-wake-up control method for a fuel cell system after shutdown, a control unit, a computer program product, and a storage medium are disclosed. The self-wake-up control method for a fuel cell system after shutdown includes (i) an ambient temperature estimation and confirmation step, wherein, in response to shutdown of the fuel cell system, remote data related to the driving of the fuel cell vehicle is acquired from outside the fuel cell vehicle, and local data related to the driving of the fuel cell vehicle is acquired from the fuel cell vehicle, and, based on the remote data and the local data, the ambient temperature of the fuel cell system is estimated and confirmed, and (ii) and a self-wake-up process determination step, wherein, based on the confirmed ambient temperature and in combination with data related to temperature variations of relevant components of the fuel cell system, a corresponding wake-up time interval and wake-up mode are determined. This can effectively eliminate the freezing risk of the fuel cell system and enhance the environmental adaptability, reliability, and durability of the fuel cell vehicle.

This application claims priority under 35 U.S.C. § 119 to application no. CN 2024 1117 1703.0, filed on Aug. 23, 2024 in China, the disclosure of which is incorporated herein by reference in its entirety.

The present application relates to the field of fuel cell systems and their control strategies, and more particularly, to a self-wake-up control method for a fuel cell system after shutdown, as well as associated control units, computer program products, and storage media.

### BACKGROUND

Proton exchange membrane fuel cells, as a typical type of electrochemical power generation device, are characterized by low operating temperature, high efficiency, fast startup, high power density, and zero emissions. As such, fuel cell systems based on proton exchange membrane fuel cells (for example, hydrogen fuel cell systems) are widely used in fuel cell vehicles (i.e., vehicles that can be powered by fuel cell systems) and other applications.

Compared with conventional internal combustion engine vehicles, fuel cell vehicles offer significant advantages in terms of efficiency and environmental friendliness. Furthermore, for fuel cell vehicles employing hydrogen fuel cell systems, in addition to strong low-temperature startup capability, the high gravimetric energy density of hydrogen enables long driving ranges. The practical application of such vehicles in the transportation sector holds tremendous potential for promoting carbon emission reduction.

Fuel cell vehicles (especially long-haul transport vehicles, etc.) are required to operate under various environmental conditions, and the actual environment is often complex and variable. Environmental conditions (such as temperature) in different regions (or locations) and at different times frequently present different scenarios or dramatic changes. For example, in hydrogen fuel cell systems, the electrochemical reaction produces water, which exhibits different states at different temperatures. If the ambient temperature is relatively high (for example, above 0° C.), the water is in a liquid state; prolonged immersion of liquid water inside the fuel cell stack can easily cause damage to the stack. If the ambient temperature is relatively low (for example, below 0° C.), the water may freeze, which can damage the membrane electrode of the fuel cell system, impede gas transport, and affect the reliability and durability of the fuel cell system.

Therefore, it is crucial to improve the reliability and durability of fuel cell systems during storage after shutdown under various environmental conditions. It is known in the art that, generally, after the shutdown (including normal and fault shutdown) of a fuel cell system, the system's own temperature and the ambient temperature are monitored, and different measures are taken at different temperatures to ensure that the fuel cell vehicle can start and operate normally. Accordingly, the fuel cell system needs to be awakened as appropriate. However, in currently known prior art, the potential impact of future ambient temperature changes on the wake-up process has not been considered, nor has a comprehensive and accurate confirmation of the ambient temperature of the fuel cell system been achieved. Typically, a timed wake-up method is adopted (for example, waking up once every hour or every few hours), but overly frequent wake-ups are unnecessary and waste energy, while excessively long intervals fail to achieve the desired monitoring purpose. Therefore, it is necessary to reasonably determine the self-wake-up duration of the fuel cell system. In addition, the control strategy of the fuel cell system after wake-up plays a decisive role in the next startup. Accordingly, how to reasonably determine the self-wake-up time interval and post-wake-up control strategy for a fuel cell system after shutdown, based on accurate confirmation of the ambient temperature, so as to avoid reduced durability and reliability of the fuel cell system due to environmental temperature changes after shutdown, is a technical problem urgently to be solved. In other words, there is a need for improvement over the currently known technology.

### SUMMARY

In view of the above background, an object of the present application is to provide a self-wake-up control method for a fuel cell system after shutdown, which can at least partially, or even completely, overcome the defects or problems mentioned in the background section above.

Another object of the present application is to provide a control unit, computer program product, and computer-readable storage medium adapted to the above control method.

To this end, according to one aspect of the present application, a self-wake-up control method for a fuel cell system after shutdown is provided, which is capable of controlling the self-wake-up process of the fuel cell system after shutdown based on remote data acquired from outside the fuel cell vehicle (e.g., a cloud platform) and local data acquired from the fuel cell vehicle itself. The self-wake-up control method for the fuel cell system after shutdown comprises:
an ambient temperature estimation and confirmation step, wherein, in response to the shutdown of the fuel cell system, remote data related to the driving of the fuel cell vehicle is acquired from outside the fuel cell vehicle, and local data related to the driving of the fuel cell vehicle is acquired from the fuel cell vehicle; based on the remote data and the local data, the ambient temperature of the fuel cell system (in other words, the fuel cell vehicle) is estimated and confirmed; and
a self-wake-up process determination step: based on the confirmed ambient temperature and in combination with data related to temperature variations of relevant components of the fuel cell system (e.g., system components, coolant circulation pipelines, and the stack), a corresponding wake-up time interval and wake-up mode (in other words, an ideal wake-up time interval and wake-up strategy adapted to the confirmation result) are determined.

According to another aspect of the present application, a control unit is further provided, comprising:
a processor; and
a memory, the memory storing computer programs/instructions, wherein the computer programs/instructions, when executed by the processor, implement the self-wake-up control method for a fuel cell system after shutdown as described above.

According to another aspect of the present application, a computer program product is provided, which comprises a computer program, and the computer program, when executed by the processor, implements the method as described above.

According to a further aspect of the present application, a computer-readable storage medium (or machine-readable storage medium) is further provided, storing executable instructions (or program instructions), which, when executed by a processor, implement self-wake-up control method for a fuel cell system after shutdown as described above.

From the above description, it can be seen that the present application proposes a novel self-wake-up control method for a fuel cell system after shutdown, as well as corresponding control units, computer program products, and storage media. The key point or main design concept lies in estimating and confirming the ambient temperature of the fuel cell system based on remote data acquired from outside the fuel cell vehicle and local data acquired from the vehicle itself. On this basis, in combination with data related to temperature variations of relevant components of the fuel cell system, a wake-up time interval and wake-up mode (control strategy) adapted thereto are adopted, thereby optimizing the self-wake-up frequency and wake-up mode of the fuel cell system, effectively eliminating the risk of freezing after shutdown, reducing the impact of temperature changes on the durability of the stack and other components, and achieving beneficial effects such as enhancing the environmental adaptability, reliability, and durability of fuel cell vehicles.

### BRIEF DESCRIPTION OF THE DRAWINGS

The features, advantages, and other aspects of the present application will be more clearly understood through the following more detailed description of the present application with reference to the accompanying drawings and in combination with exemplary examples. In the accompanying drawings:

FIG. 1 is a simplified schematic diagram of a typical configuration (or integrated design) of a known conventional fuel cell system;

FIG. 2 is a schematic diagram of a method for estimating the internal temperature of a fuel cell stack in a fuel cell system according to an exemplary embodiment of the present application;

FIGS. 3A to 3D are schematic diagrams illustrating temperature variations of various relevant components of a fuel cell system at different ambient temperatures after system shutdown;

FIG. 4 is a schematic diagram of a mapping relationship (or temperature drop table) relating to the temperature drop time of various relevant components of a fuel cell system at different ambient temperatures, which may be stored on a cloud platform;

FIG. 5 is a schematic diagram of a method for estimating and confirming the ambient temperature of a fuel cell system according to an exemplary embodiment of the present application;

FIG. 6 is a schematic diagram illustrating the basic logic or overall flow of a self-wake-up control method for a fuel cell system after shutdown according to an exemplary embodiment of the present application.

### DETAILED DESCRIPTION

The specific examples of the present application and other details are described in detail below with reference to the accompanying drawings. It will be understood that the examples given herein and their related descriptions shall be understood to be exemplary and not to constitute a limitation to the present application.

Furthermore, it should be noted that, for the sake of brevity and to facilitate a clearer understanding of the key design concepts or substantive features of the present application, the specification and accompanying drawings herein primarily describe or illustrate content related to the main design points or principles of the present application, while other portions (particularly detailed descriptions of known technologies in the art) are omitted or simplified. The fundamental principles, control processes, specific details, and the like of these omitted portions are well-known in the art or can be specifically applied by those skilled in the art based on existing knowledge and application environments. Accordingly, such content is not repeated or illustrated in detail herein. In other words, methods (such as control processes) and techniques that are well known in the field have not been described or illustrated in detail so as to avoid unnecessarily obscuring the core or substance of the present application.

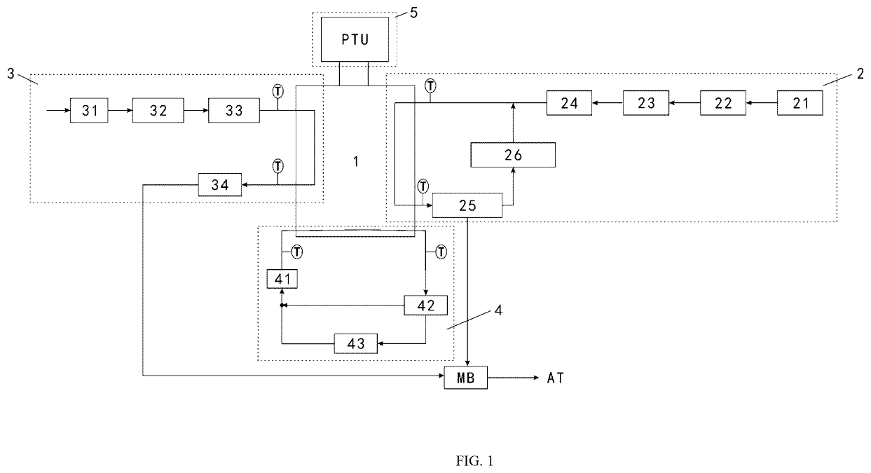

To facilitate a clearer understanding of various aspects of the present application, a brief description of a typical configuration of a known fuel cell system is first provided with reference to FIG. 1, prior to describing the technical solutions of the present application.

As shown in FIG. 1, taking as an example a hydrogen fuel cell system commonly used in fuel cell vehicles (though not limited thereto), the fuel cell system generally comprises a stack 1, an anode subsystem (or hydrogen subsystem) 2, a cathode subsystem (or air subsystem) 3, a thermal management subsystem 4, and an electrical and control subsystem 5. The anode subsystem 2 primarily supplies hydrogen to the anode of the stack, while the cathode subsystem 3 primarily supplies air to the cathode of the stack, thereby ensuring the normal progress of the electrochemical reaction. The thermal management subsystem 4 is mainly used to ensure that the stack 1 operates at an appropriate temperature, maintaining the stack 1 in a suitable condition. The electrical and control subsystem 5 is mainly used for power distribution and control of the above subsystems.

The stack 1 may be formed by connecting multiple fuel cell units in series, each of which may comprise a proton exchange membrane, catalyst layer, diffusion layer, and bipolar plate, among others.

The anode subsystem 2 may include a hydrogen tank 21, a shut-off valve 22, a pressure-reducing valve 23, a proportional valve 24, an anode purge valve 25, and an anode recirculation system 26. More specifically, in the anode subsystem 2, hydrogen from the hydrogen tank 21 passes through the shut-off valve 22 and pressure-reducing valve 23 to reach the proportional valve 24, which controls the pressure of the anode gas (hydrogen in this case) entering the stack 1. After entering the stack 1, the hydrogen participates in the reaction, and the unreacted gas may be mixed with fresh hydrogen via the anode recirculation system 26 before re-entering the stack 1. As the electrochemical reaction proceeds, nitrogen (N2) and water vapor accumulate on the anode side, affecting the reaction. Therefore, the anode purge valve 25 is intermittently opened to increase the hydrogen concentration in the anode recirculation system 26.

The cathode subsystem 3 may include an air filter 31, an air compressor 32, an intercooler 33, and a backpressure valve 34. More specifically, in the cathode subsystem 3, ambient air passes through the air filter 31 and enters the air compressor 32. The resulting high-temperature, high-pressure gas is cooled by the intercooler 33 before entering the stack 1 to participate in the reaction. A backpressure valve 34 is provided at the outlet of the stack cathode, and the exhaust gas produced after the reaction is discharged to the atmosphere AT via a mixing box MB, which is in fluid communication with both the anode purge valve 25 and the backpressure valve 34.

The thermal management subsystem 4 may include a pump (e.g., water pump) 41, a thermostat 42, and a radiator 43, and, with the aid of these components, forms a coolant circulation pipeline in which coolant can circulate. More specifically, in the thermal management subsystem 4, the pump 41 is arranged at the inlet of the stack cooling circuit to drive coolant into the stack 1 and carry away the heat generated by the stack 1. When the coolant temperature is low, the thermostat 42 opens, allowing the coolant to circulate through a small loop that bypasses the radiator 43. When the coolant temperature is high, the coolant can circulate through a large loop including the radiator 43, thereby dissipating heat via the radiator 43 and ensuring that the stack 1 operates within an appropriate temperature range.

The electrical and control subsystem 5 mainly includes a PTU (Power Transfer Unit) and a controller (or control unit, not shown). The PTU is mainly used to supply power to various actuators in the fuel cell system (such as the anode recirculation system 26, anode purge valve 25, air compressor 32, backpressure valve 34, pump 41, etc.), while the controller is mainly used to coordinate the operation of the actuators to ensure stable and reliable operation of the fuel cell system.

As can also be seen from FIG. 1, temperature sensors, denoted by the symbol \textcircled{T}, are provided at the inlets and outlets of the stack cathode, anode, and coolant, for real-time monitoring of the temperature of fluids entering and exiting the stack 1.

As described above, fuel cell vehicles are required to operate in complex and variable environments, and the ambient temperature of the fuel cell system (in other words, the fuel cell vehicle) does not necessarily synchronize with its actual temperature. That is, the fuel cell system is affected by the environment, and heat transfer requires a certain amount of time. Generally, after a delay, the fuel cell system (including its components and the coolant circulation pipeline or coolant used therein) will reach the same temperature as its environment. Moreover, the temperature delay time for each component of the fuel cell system is not the same and is related to the fuel cell system itself and its integrated arrangement. Therefore, how to accurately determine (or confirm) the ambient temperature of the fuel cell system and, on this basis, reasonably determine the self-wake-up time interval after system shutdown and the control strategy after wake-up, so as to avoid reduced durability and reliability of the fuel cell after shutdown due to changes in ambient temperature, is a technical problem urgently to be solved.

In particular, the inventors of the present application have noted and realized that, for long-haul transport vehicles such as long-distance freight vehicles, which are characterized by a wide operating range, relatively fixed routes (or operating regions), and long-distance travel in a short period, the above problems are even more pronounced, and there is an urgent need and practical significance in solving these problems.

Based on the above background, the present application proposes a novel self-wake-up control method for a fuel cell system after shutdown. The main design concept or principle lies in the ability to accurately estimate (or predict) and confirm the ambient temperature of the fuel cell system (i.e., the vehicular fuel cell system) of a fuel cell vehicle, based on remote data acquired from outside the fuel cell vehicle (for example, via a cloud platform) and local data acquired from the vehicle itself (for example, via onboard or installed sensors). Furthermore, reasonable control of the self-wake-up process of the fuel cell system after shutdown is achieved according to the different cooling rates of relevant (or several) components of the fuel cell system (i.e., correspondingly determining the self-wake-up interval and related wake-up strategies after system shutdown). Ultimately, this aims to reduce the energy consumption of the fuel cell system, enhance environmental adaptability, and improve its durability and reliability.

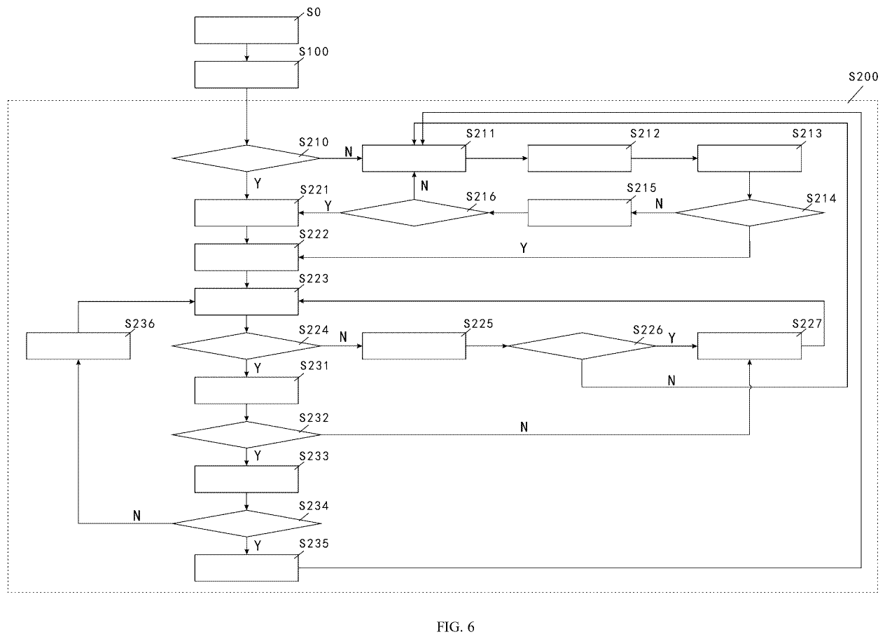

More specifically, as illustrated in FIG. 6 and described in detail below, according to an exemplary embodiment of the present application, a self-wake-up control method for a fuel cell system after shutdown is provided. This method enables the control of the self-wake-up process of the fuel cell system of a fuel cell vehicle after shutdown, based on remote data acquired externally and local data acquired from the vehicle. The self-wake-up control method for the fuel cell system after shutdown may include:

An ambient temperature estimation and confirmation step S100, wherein, in response to the shutdown of the fuel cell system (i.e., Step S0, in which, for example, the shutdown state of the fuel cell system may be determined by detecting the system status or according to a received signal related to system shutdown), remote data related to the operation of the fuel cell vehicle is acquired from outside the vehicle, and local data related to the operation of the vehicle is acquired from the vehicle itself (which may, for example, be data recorded by the fuel cell control unit of the system, but is not limited thereto). The ambient temperature of the fuel cell system is then estimated and confirmed based on the remote and local data; and
a self-wake-up process determination step S200, wherein, based on the confirmed ambient temperature and in combination with data related to the temperature variation of relevant components of the fuel cell system, a corresponding wake-up time interval and wake-up mode are determined.

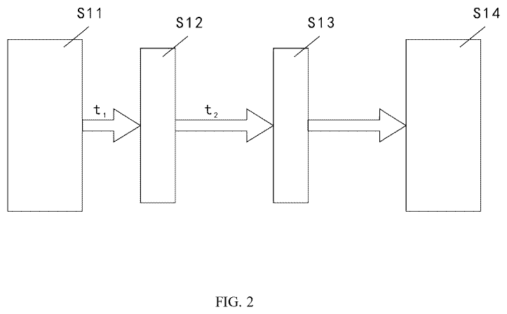

Before describing in greater detail the novel self-wake-up control method for a fuel cell system after shutdown according to the present application, reference is first made to FIGS. 2 to 5 to describe the temperature determination method and the acquisition of reference data relevant to the present application.

In the present application, the temperature variation process of relevant components of the fuel cell system refers to the process in which, after shutdown and while stationary in the actual storage environment, the temperature of relevant components gradually decreases to the ambient temperature.

FIG. 2 schematically illustrates a feasible method (or approach) for determining the internal temperature of the fuel cell stack of a fuel cell system according to an exemplary embodiment of the present application.

It should be noted that the stack internal temperature determination method shown in FIG. 2 is based on the following facts: after shutdown and when stored in an actual environment with an ambient temperature T0, the internal temperature of the stack of an actually assembled and integrated fuel cell system will vary with the ambient temperature. The main principle is that, at the system level, temperature sensors arranged at the cathode, anode, and coolant inlets and outlets of the stack are used to monitor in real time the temperature of fluids entering and exiting the stack. Temperature variation tests are conducted under actual storage conditions, so that the overall temperature variation related to the stack can be monitored and, thus, the change in the stack's internal temperature can be reliably determined.

More specifically, as shown in FIG. 2, in Step S11, the ambient temperature T0 in the storage environment of the fuel cell system (in other words, the fuel cell vehicle) is acquired, and the stack temperature T1 at the time of system shutdown is recorded, where T1 may be acquired as the average temperature of the coolant entering and exiting the stack. Subsequently, the values of each temperature sensor in the fuel cell system are monitored in real time, and no operation is performed on the fuel cell system. On this basis, after a stationary period t1 for the fuel cell system, in Step S12, the average temperature T2 of the coolant entering and exiting the stack is measured and acquired. Then, after running the pump 41 for a period t2 to ensure uniform heat exchange between the coolant and the stack, in Step S13, the average temperature T2′ of the coolant entering and exiting the stack is measured and acquired (generally, the cooling rate of the stack will not exceed that of the coolant, i.e., T2≤T2′). Subsequently, in Step S14, based on the heat capacity M1 of the stack and the heat capacity M2 of the thermal management subsystem, the stack temperature (or stack internal temperature) T3 is calculated using the following formula: T3=[(T2′−T2)×M2+M1×T2]/M1.

In addition, for other components of the fuel cell system, the temperature variation corresponding to changes in ambient temperature can be determined as follows: the changes in temperature sensors at the anode/cathode inlets and outlets can be considered representative of the temperature variation of the anode/cathode subsystem components (i.e., anode and cathode components) or pipelines. The average value of the four temperature sensors at the anode/cathode inlets and outlets may be taken as Tc. For the temperature variation of the coolant circulation pipeline (or loop), during the stationary process of the fuel cell system, without any operation, the values of the temperature sensors at the inlet and outlet of the coolant circulation pipeline are recorded in real time and averaged to acquire the temperature of the coolant circulation pipeline, denoted as TL.

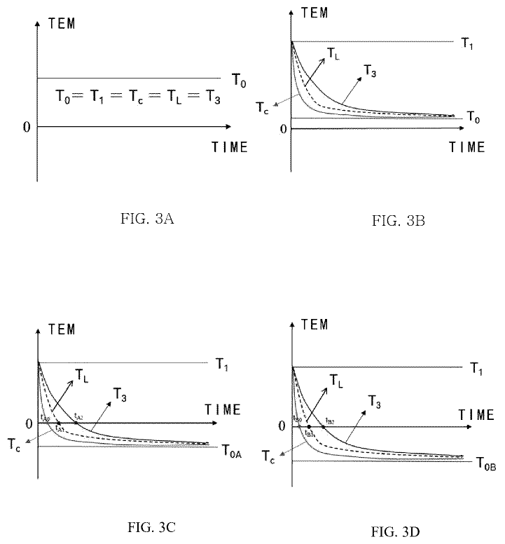

By way of the above temperature determination methods, and based on a large number of experiments, schematic diagrams (or temperature variation curves) of the temperature variation of various relevant components of the fuel cell system after shutdown under the influence of ambient temperature, as shown in FIGS. 3A to 3D, can be acquired. In FIGS. 3A to 3D, TIME denotes the (system) stationary time, TEM denotes temperature, T0 denotes the ambient temperature of the storage environment at the time of system shutdown, T1 denotes the stack temperature at the completion of system shutdown, Tc denotes the temperature of the anode and cathode components, TL denotes the temperature of the coolant circulation pipeline, T3 denotes the stack temperature (or internal stack temperature), TOA denotes an ambient temperature below 0° C., and TOB denotes another, lower ambient temperature below 0° C.

As can be seen from FIGS. 3A to 3D, depending on the ambient temperature and the temperature of the fuel cell system at the time of shutdown, the following different scenarios can be distinguished.

Generally, the temperature of the fuel cell system after shutdown is relatively high, for example, approximately 35° C. to 45° C. FIG. 3A illustrates the scenario in which the ambient temperature is essentially the same as the temperature of the fuel cell system (in other words, the stack) at the time of shutdown, i.e., 0<T0=T1. This situation may occur during hot summer days, when the temperatures of the various components of the fuel cell system (especially the anode and cathode components) remain essentially unchanged.

FIG. 3B depicts the scenario where the ambient temperature is lower than the temperature of the fuel cell system (e.g., the stack) at shutdown, with both being greater than 0° C., i.e., 0<T0<T1. As shown in the figure, as the stationary time of the fuel cell system increases, the temperatures of the anode and cathode components, the coolant circulation pipeline (or coolant), and the stack all gradually decrease, and the rate of temperature drop for each gradually slows down. At any given moment, the temperature of the anode and cathode components is lower than that of the coolant circulation pipeline, which in turn is lower than that of the stack. Ultimately, all three reach a temperature value almost identical to the ambient temperature.

FIGS. 3C and 3D respectively illustrate scenarios where the ambient temperature is lower than the temperature of the fuel cell system at shutdown and is below 0° C. In FIG. 3C, T0A=T0<0<T1, and in FIG. 3D, T0B=T0<0<T1.

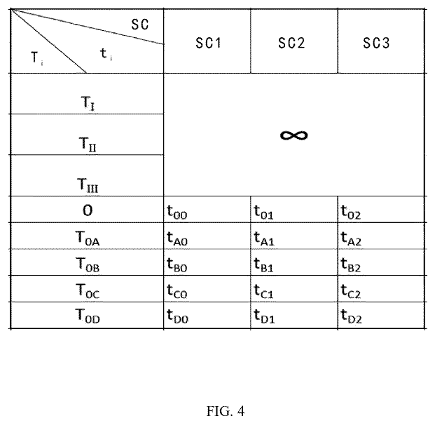

Similarly, as can be seen from FIGS. 3C and 3D, as heat exchange with the surrounding environment proceeds, the temperatures of the anode and cathode components, the coolant circulation pipeline (thermal management subsystem), and the stack of the fuel cell system all gradually decrease. With increasing stationary time, these temperatures will each drop below 0° C. and eventually approach the actual ambient temperature. Taking the time required for the temperatures of the anode and cathode components, the coolant circulation pipeline (or coolant), and the stack of the fuel cell system to each drop to 0° C., for FIG. 3C, the corresponding times are tA0, tA1 and tA2, and for FIG. 3D, the corresponding times are tB0, tB1 and tB2. Accordingly, a mapping relationship (for example, a temperature drop time table, but not limited thereto) as shown in FIG. 4 can be obtained, relating the temperature drop times of the relevant components of the fuel cell system (more specifically, the anode and cathode components, the coolant circulation pipeline, and the stack) at different ambient temperatures. This provides a basis (or data support) for determining the self-wake-up time and corresponding wake-up strategy in the self-wake-up control method after shutdown of the fuel cell system according to the present application.

It should be noted that in FIG. 4, Ti denotes the ambient temperature, ti denotes the time required for the temperature to drop from the initial value to 0° C. (i.e., the temperature drop time), SC denotes the relevant components of the fuel cell system, SC1 denotes the anode and cathode components, SC2 denotes the coolant circulation pipeline, SC3 denotes the stack, T_{I}, T_{II}, T_{III} respectively denote different ambient temperatures above 0° C., T0_{A}, T0_{B}, T0_{C}, T0_{D} respectively denote different ambient temperatures below 0° C., t00, t01, t02, . . . , tD0, tD1, tD2 respectively denote the temperature drop times corresponding to each relevant component at different ambient temperatures (i.e., the time required for each relevant component to drop from the initial temperature to 0° C. at different ambient temperatures).

As can be seen from FIG. 4, when the ambient temperature is greater than 0° C., the temperatures of the relevant components of the fuel cell system will not drop to 0° C., i.e., the temperature drop time is infinite (o). When the ambient temperature is equal to or lower than 0° C., the time required for the temperatures of the relevant components of the fuel cell system to drop to 0° C. is recorded, thereby obtaining a mapping relationship (which may be presented as a map or table, but is not limited thereto and may, for example, be pre-stored in a cloud platform for subsequent use as backup data for the control method of the present application) relating to the time required for each relevant component to drop from the initial temperature to 0° C. at different ambient temperatures below 0° C.

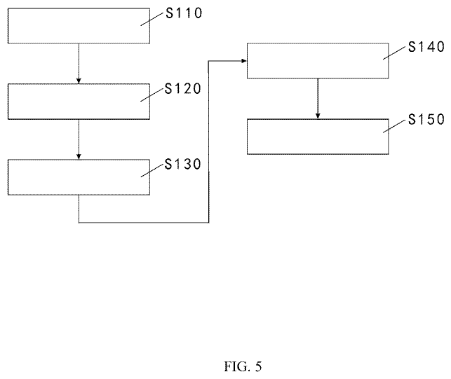

Additionally, FIG. 5 schematically illustrates a method for estimating and confirming the ambient temperature of a fuel cell system according to an exemplary embodiment of the present application, which may be used in the ambient temperature estimation and confirmation step S100 as described above (as a basis for subsequent processing, for example, to determine the self-wake-up time interval and corresponding wake-up mode of the fuel cell system after shutdown in conjunction with the aforementioned mapping relationship or temperature drop time table).

More specifically, as shown in FIG. 5, an exemplary embodiment of the present application provides a method for estimating and confirming the ambient temperature of a fuel cell system, which may include:
a positioning information acquisition step (S110), wherein, based on the vehicle-mounted cloud control unit of the fuel cell vehicle and
big data from the cloud platform, real-time positioning information of the fuel cell vehicle (in other wors, the fuel cell system) is acquired;
a region and time determination step S120, wherein, based on the real-time positioning information, the current region and current time of the fuel cell vehicle are determined;
a temperature acquisition step S130, wherein the current ambient temperature of the fuel cell system is acquired in real time, the historical minimum temperature of the current region at the same time K years ago stored in the cloud platform is acquired, and the possible minimum temperature of the current region in the next P days predicted by the cloud platform is acquired; (for example, based on a cloud platform data model such as a pre-established weather prediction model in the cloud platform, which offers advantages such as significantly improved timeliness and accuracy, effective saving of computing resources, and enhanced work efficiency; the cloud platform weather prediction model may be established based on historical/future meteorological data for the relevant driving region of the fuel cell vehicle and trained using artificial intelligence, but is not limited thereto);
a temperature comparison step S140, wherein the current ambient temperature, the historical minimum temperature, and the possible minimum temperature are compared and the minimum value (i.e., the lowest ambient temperature) is taken; and
an ambient temperature confirmation step S150, wherein the minimum value is determined as the confirmed ambient temperature,
where K and P are natural numbers greater than or equal to 1, determined based on experiments or experience (furthermore, K and P may be identical or different from each other, and may be appropriately adjusted or varied according to specific applications and actual requirements).

In other words, according to the method shown in FIG. 5, for example, the position of a fuel cell vehicle (or fuel cell system) may be acquired in real time based on the vehicle-mounted CCU (Cloud Controller Unit) and cloud platform big data. Subsequently, the regional location and current time may be determined, and, based on data stored on and acquired in real time from the cloud platform, the current ambient temperature, the minimum temperature value at the same location and same time (day) in the past K years, and the possible lowest temperature value in the region for the upcoming P days may be acquired. These three values are then compared, and the minimum value is selected to determine the confirmed ambient temperature.

With reference to FIG. 6, further details of the self-wake-up control method for a fuel cell system after shutdown, according to exemplary embodiments of the present application, are described in detail below.

According to an advantageous and feasible embodiment of the present application, the fuel cell vehicle may be configured to be wirelessly communicatively connected (i.e., networked) with an external cloud platform, so that the aforementioned remote data may be acquired from the cloud platform. Furthermore, the relevant components of the fuel cell system may include system components, coolant circulation pipelines, and the stack. Data related to temperature variation of the relevant components of the fuel cell system may include the real-time temperature of said components, coolant circulation pipelines, and the stack, as well as the time required for their temperature to drop from different ambient temperatures to a first low-temperature threshold (which is related to their respective temperature drop rates).

According to an advantageous and feasible embodiment of the present application, the wake-up modes involved in the self-wake-up control method for the fuel cell system after shutdown may include the following levels:
a mild system wake-up mode, wherein, the temperatures of various sensors in the fuel cell system are acquired and the confirmed ambient temperature for the fuel cell system is updated in real time (this updating process may, for example, be carried out using the method shown in FIG. 5, but is not limited thereto);
a moderate system wake-up mode, wherein, in addition to the operations performed in the mild system wake-up mode, actuators related to purging of system components in the fuel cell system are also awakened, and the system components are purged (for example, and without limitation, the air compressor 32, backpressure valve 34, anode purge valve 25, pump 41, and, if necessary, the anode recirculation system 26 may be awakened, and only the system components are purged to prevent freezing and to expel residual condensed water inside the stack); and
a high-level system wake-up mode, wherein, in addition to the operations performed in the moderate system wake-up mode, the stack of the fuel cell system is started, and the interior of the stack is purged (i.e., the entire fuel cell system is awakened to precisely control the water content inside the stack, thereby preparing the stack for low-temperature storage, preventing low-temperature damage, and ensuring readiness for the next low-temperature start-up of the fuel cell system).

As can be seen from the foregoing description, according to an advantageous and feasible embodiment of the present application, the fuel cell system may be a hydrogen fuel cell system, which may include an anode subsystem, a cathode subsystem, and a thermal management subsystem. The anode subsystem includes an anode purge valve, the cathode subsystem includes an air compressor and a backpressure valve, and the thermal management subsystem includes a pump for pumping coolant. In the moderate system wake-up mode, the process of awakening actuators related to purging of system components may include awakening the air compressor, backpressure valve, anode purge valve, and pump.

Thus, according to the present application, different levels of self-wake-up modes (in other words, different control strategies) may be executed based on the confirmed ambient temperature. Depending on the degree of system self-wake-up, mild, moderate, or high-level system wake-up may be performed. When the mild system wake-up is executed, the temperatures of various sensors in the fuel cell system are acquired in real time and the confirmed ambient temperature is updated. When the moderate system wake-up is executed, in addition to real-time acquisition of sensor temperatures and updating the confirmed ambient temperature, relevant actuators (e.g., air compressor, backpressure valve, anode purge valve, pump, etc.) are awakened, and only the system components are purged to prevent freezing and expel residual condensed water from the stack. When the high-level system wake-up is executed, in addition to the operations of moderate system wake-up, the stack is started and its interior is purged, precisely controlling its internal water content to ensure reliable storage at low temperatures, prevent low-temperature damage, and prepare for the next low-temperature start-up of the fuel cell system.

It should be noted that further details regarding the above mild, moderate, and high-level system wake-up modes may be appropriately designed, selectively applied, or specifically adapted by those skilled in the art based on the design principles and disclosures of the present application, as well as existing knowledge and application environments in the field. Therefore, for the sake of brevity, further elaboration is omitted here.

According to an advantageous and feasible embodiment of the present application, the fuel cell system may be a hydrogen fuel cell system, and the first low-temperature threshold may be set to 0° C. Furthermore, the time required for the components, coolant circulation pipelines, and stack to cool from different ambient temperatures to 0° C. may be pre-determined through experimentation, and their mapping relationships may be pre-stored in the cloud platform, thereby serving as backup data for the self-wake-up process determination step S200.

Under the above circumstances, as shown in FIG. 6, according to an advantageous and feasible embodiment of the present application, the self-wake-up process determination step S200 may comprise:
a confirmed temperature comparison and determination step S210, wherein the confirmed ambient temperature is compared with 0° C. and it is determined whether it is less than 0° C.;
a first wake-up time interval determination step S211 and a subsequent first wake-up mode determination step S212, wherein, in the first wake-up time interval determination step S211, if the confirmed ambient temperature is determined to be not less than 0° C. (i.e., the determination result of the confirmed temperature comparison and determination step S210 is N), the wake-up time interval after the shutdown of the fuel cell system is determined as the first wake-up time interval t based on the mapping relationship stored in the cloud platform, and in the first wake-up mode determination step S212, the first wake-up mode presented as the mild system wake-up mode is executed; or
a second wake-up time interval determination step (S221) and a subsequent second wake-up mode determination step (S222), wherein, in the second wake-up time interval determination step (S221), if the confirmed ambient temperature is determined to be less than 0° C. (i.e., the determination result of the confirmed temperature comparison and determination step S210 is Y), the wake-up time interval is determined as the second wake-up time interval t′ based on the mapping relationship stored in the cloud platform, and in the second wake-up mode determination step (S222), the second wake-up mode presented as the moderate system wake-up mode is executed.

Furthermore, as shown in FIG. 6, according to an advantageous and feasible embodiment of the present application, after the first wake-up mode determination step S212, the self-wake-up control method after shutdown of the fuel cell system may further comprise:

A system components and coolant circulation pipeline temperature acquisition step S213, in which the actual temperature of the components (for example, the average value of four temperature sensors at the anode/cathode inlets and outlets, but not limited thereto) and the actual temperature of the coolant circulation pipeline (for example, the average value of temperature sensors at the inlet and outlet of the coolant circulation pipeline, but not limited thereto) are acquired, and the lower value between the two is selected;
an actual temperature comparison and determination step S214, wherein the lower value is compared with 0° C. and it is determined whether it is less than 0° C.; and
based on the comparison result between the lower value and 0° C., different wake-up processes are executed.

Under the above circumstances, as shown in FIG. 6, according to an advantageous and feasible embodiment of the present application, the different wake-up processes may comprise:

If the lower value is not less than 0° C. (i.e., the determination result of the actual temperature comparison and determination step S214 is N), the confirmed ambient temperature is updated (step S215), compared with 0° C., and determined whether it is less than 0° C. (step S216). If the re-confirmed ambient temperature is not less than 0° C. (i.e., the determination result of step S216 is N), the process returns to the first wake-up time interval determination step (S211); if the re-confirmed ambient temperature is less than 0° C. (i.e., the determination result of step S216 is Y), the process proceeds to the second wake-up time interval determination step S221; and

If the lower value is less than 0° C. (i.e., the determination result of the actual temperature comparison and determination step S214 is Y), the process proceeds to the second wake-up mode determination step S222.

In addition, as shown in FIG. 6, according to an advantageous and feasible embodiment of the present application, after the second wake-up mode determination step S222, the self-wake-up control method after shutdown of the fuel cell system may further comprise:
a system components and coolant circulation pipeline temperature acquisition step S223, wherein the actual temperature of the components and the actual temperature of the coolant circulation pipeline are acquired, and the lower value of the two is selected;
an actual temperature comparison and determination step S224, wherein the lower value is compared with 0° C. and it is determined whether it is less than 0° C.; and
based on the comparison result between the lower value and 0° C., different wake-up processes are executed.

Under the above circumstances, as shown in FIG. 6, according to an advantageous and feasible embodiment of the present application, the different wake-up processes may comprise:

If the lower value is not less than 0° C. (i.e., the determination result of the actual temperature comparison and determination step S224 is N), the confirmed ambient temperature is updated (step S225), compared with 0° C., and determined whether it is less than 0° C. (step S226). If the re-confirmed ambient temperature is not less than 0° C. (i.e., the determination result of step S226 is N), the process returns to the first wake-up time interval determination step S211; if the re-confirmed ambient temperature is less than 0° C. (i.e., the determination result of step S226 is Y), the wake-up time interval is re-determined as a third wake-up time interval t″ (step S227), and then the process returns to the system components and coolant circulation pipeline temperature acquisition step S223; and

In the case where said lower value is less than 0° C. (i.e., the determination result of the actual temperature comparison and determination step S224 is Y), the confirmed ambient temperature is updated (step S231), compared with 0° C., and it is determined whether it is less than 0° C. (step S232). If the re-confirmed ambient temperature is not less than 0° C. (i.e., the determination result of step S232 is N), the wake-up time interval is re-determined as the third wake-up time interval t″ (step S227), and the process subsequently returns to the system components and coolant circulation pipeline temperature acquisition step S223. If the re-confirmed ambient temperature is less than 0° C. (i.e., the determination result of step S232 is Y), the temperature of the stack is acquired (step S233, which may be performed according to the method shown in FIG. 2, but is not limited thereto), and it is compared with a second low-temperature threshold that is lower than the first low-temperature threshold to determine whether it is less than the second low-temperature threshold (step S234). If the temperature of the stack is less than the second low-temperature threshold (i.e., the determination result of step S234 is Y), the third wake-up mode corresponding to the high-level system wake-up mode is executed (step S235), and the process subsequently returns to the first wake-up time interval determination step S211. If the temperature of the stack is not less than the second low-temperature threshold (i.e., the determination result of step S234 is N), the wake-up time interval is re-determined as the fourth wake-up time interval t″ (step S236), and the process subsequently returns to the system components and coolant circulation pipeline temperature acquisition step S223.

According to an advantageous and feasible embodiment of the present application, based on a mapping relationship pre-stored in the cloud platform, the time required for the components, the coolant circulation pipeline, and the stack to decrease from different ambient temperatures to 0° C. can be represented as tl0, tl1 and tl2, respectively. The first wake-up time interval t, the second wake-up time interval t′, the third wake-up time interval t″, and the fourth wake-up time interval t″ may be determined according to the following formulas, respectively: t=N× tl0, t′=tl0, t″=tl1−tl0, t″=tl2−tl1 where N is a positive integer (which may be determined experimentally or empirically, and may vary according to specific applications or actual needs), and tl0, tl1, and tl2 vary accordingly with changes in ambient temperature.

According to an advantageous and feasible embodiment of the present application, the second low-temperature threshold may be set within the range of −15° C. to −10° C. In fact, the second low-temperature threshold is usually related to system integration design and low-temperature start-up strategies, and may be determined experimentally or empirically, and may be appropriately varied according to specific applications or actual needs.

To provide a clearer and more intuitive understanding of the technical solution of the present application, an overview of the self-wake-up control method for a fuel cell system after shutdown according to an exemplary embodiment of the present application is given below with reference to FIG. 6.

As shown in FIG. 6, in step S0, the fuel cell system completes shutdown and subsequently enters the self-wake-up phase of the present application. In step S100, for example, under the control of the fuel cell control unit, the ambient temperature of the fuel cell system may be confirmed according to the method shown in FIG. 5, and in step S210, it is determined whether the confirmed ambient temperature is less than 0° C. When the confirmed ambient temperature is less than 0° C., in step S221, based on the confirmed ambient temperature and by retrieving the pre-stored mapping relationship in the cloud platform as previously described (for example, the confirmed ambient temperature may be compared with a temperature drop table stored in the cloud platform, but is not limited thereto), the wake-up time is determined as the second wake-up time interval t′. Upon reaching (or after) the second wake-up time interval t′, moderate system wake-up is performed in step S222. On the other hand, when the confirmed ambient temperature is not less than (i.e., equal to or greater than) 0° C., in step S211, the wake-up time of the fuel cell system is determined as the first wake-up time interval t. Upon reaching (or after) the first wake-up time interval t, mild system wake-up is performed in step S212. Subsequently, in step S213, the actual temperature Tc of the fuel cell system components and the actual temperature TL of the coolant circulation pipeline are acquired, and the lower value of the two is selected. Then, in step S214, the lower value is compared with 0° C. If the lower value is below 0° C., moderate system wake-up is performed in step S222; otherwise, in step S215, the confirmed ambient temperature is updated (which may be performed with reference to the method shown in FIG. 5, but is not limited thereto). When the updated ambient temperature is not less than 0° C., the first wake-up time interval t is maintained (i.e., returning to step S211); otherwise, the process proceeds to step S222.

After step S222 (i.e., after the completion of moderate system wake-up), in step S223, the actual temperature Tc of the fuel cell system components and the actual temperature TL of the coolant circulation pipeline are acquired, and the lower value of the two is selected. Next, in step S224, the lower value is compared with 0° C. If the lower value is not less than 0° C., at step S225, the confirmed ambient temperature is updated, and at step S226, the updated ambient temperature is compared with 0° C. When the updated ambient temperature is lower than 0° C., at step S225, the wake-up time is changed to the third wake-up time interval t″. Upon reaching the wake-up time, step S223 is continued, wherein the temperatures of the system components and the coolant circulation pipeline are monitored. Conversely, if the wake-up time remains at the first wake-up time interval t, step S211 continues to be executed. If the lower value between the actual temperature Tc of the fuel cell system components and the actual temperature TL of the coolant circulation pipeline is less than 0° C., at step S231, the confirmed ambient temperature is still updated, and at step S232, the updated ambient temperature is compared with 0° C. When the updated ambient temperature is not lower than 0° C., the wake-up time is changed to the third wake-up time interval t″ (i.e., returning to step S227). Otherwise, at step S233, the stack temperature T3 is acquired (or predicted), which may be performed in the manner shown in FIG. 2, but is not limited thereto, and at step S234, the stack temperature T3 is compared with the second low-temperature threshold Tlow. When the stack temperature T3 is greater than or equal to the second low-temperature threshold Tlow, at step S236, the wake-up time is changed to the fourth wake-up time interval t″. When the stack temperature T3 is less than the second low-temperature threshold Tlow, at step S235, a high-level system wake-up is performed.

It should be noted that the above wake-up times may be determined based on a pre-stored mapping relationship in the cloud platform (for example, the mapping relationship or temperature drop table diagram related to the temperature drop time of each component of the fuel cell system at different ambient temperatures as shown in FIG. 4), i.e., t=N× tl0, where N is a positive integer, t′=tl0, t″=tl1−tl0, t″=tl2−tl1, l is 0, A, B, C, D, . . . .

From the above description, it can be seen that, in the self-wake-up control method for a fuel cell system after shutdown according to the present application, under normal circumstances, the moderate system wake-up and the high-level system wake-up are each executed only once. That is, once the fuel cell system meets the required conditions and a moderate or high-level system wake-up has been executed, no further moderate or high-level system wake-up will be performed in the later stages. After both the moderate and high-level system wake-ups have been completed, the system's wake-up time will be updated and executed according to the first wake-up time interval, during which only a mild system wake-up will be performed.

Thus, the present application provides a novel self-wake-up control method for a fuel cell system after shutdown (in particular, for example, a method and strategy for determining the self-wake-up time interval and wake-up mode after shutdown of a fuel cell system based on a cloud platform). This method can utilize remote data obtained externally from the fuel cell vehicle (e.g., from a cloud platform) and local data obtained from the vehicle itself to accurately estimate/predict and confirm the ambient temperature of the fuel cell system (in particular, for example, future ambient temperature during operation of the fuel cell vehicle can be predicted based on remote data and utilized). Based on the different cooling rates of different components of the fuel cell system, the method correspondingly determines different wake-up time intervals and wake-up modes for the fuel cell system (for example, a mapping relationship related to the temperature drop of relevant components may be obtained according to the temperature change rates of these components in different environments, such as a temperature drop table diagram, but not limited thereto). This lays the foundation for the rational formulation of subsequent self-wake-up processes and enables the adoption of different wake-up time intervals and wake-up levels in stages/steps according to the confirmed ambient temperature, i.e., using different control strategies. Ultimately, this can achieve significant beneficial effects such as reducing the energy consumption of the fuel cell system, enhancing environmental adaptability, and improving durability and reliability.

In addition, it should be noted that the above description mainly uses the case of a hydrogen fuel cell system and a cloud platform as an example (thus, the method can be applied and developed in a fuel cell system cloud platform) to describe in detail the specific embodiments of the self-wake-up control method for a fuel cell system after shutdown according to the present application. However, it is clearly not limited thereto.

Furthermore, it should be noted that, regarding the use of the cloud platform, the establishment of the cloud platform data model, and training methods involved in the present application, since these generally belong to known technology in the field, and those skilled in the art can apply them specifically according to existing knowledge and application environments, further details are omitted here for brevity.

Moreover, as can be seen from the foregoing description, the self-wake-up control method for a fuel cell system after shutdown according to the present application is particularly applicable to long-distance transport vehicles, among others, but is not limited thereto.

Additionally, it is evident, as described above, that the exemplary embodiments and their steps described above in conjunction with the accompanying drawings are provided only as examples for ease of understanding the present application and are not intended to limit the present application. For those skilled in the art, it is clear that, without departing from the basic principles or technical concepts of the present application, the number, order, and specific content of the steps in the embodiments shown in the drawings may be appropriately increased, decreased, or adjusted according to specific applications or actual needs (for example, the judgment conditions and specific parameter values in each step may be appropriately changed or adjusted). Moreover, regarding further details not exhaustively described herein, those skilled in the art may design or selectively apply them based on known technology and common knowledge in the field, and such details are not enumerated herein for brevity.

It should be understood that, in the present application, the terms “first,” “second,” “third,” etc., are only used to distinguish one element (e.g., value, step, or state) from another and do not imply any limitation on the present application.

In accordance with the aforementioned self-wake-up control method for a fuel cell system after shutdown, the present application also provides a related (in other words, corresponding) control unit, which may include:
a processor; and
a memory, the memory storing computer programs/instructions, wherein the computer programs/instructions, when executed by the processor, implement the self-wake-up control method for a fuel cell system after shutdown as described above.

Evidently, the self-wake-up control method for a fuel cell system after shutdown as disclosed in the present application (also referred to as a control method) may be executed by way of the control unit of the present application. The various technical features, specific details, and technical effects described with respect to the method are equally applicable to the aforementioned control unit. Moreover, each step and technical detail of the method described above may be stored in the control unit in the form of software, or may be implemented by way of a combination of software and hardware. In addition, the control unit of the present application may be integrated into various existing control units of a fuel cell vehicle (for example, a vehicle control unit or a fuel cell control unit, but not limited thereto), although it is clearly not limited to such implementations.

Furthermore, according to another aspect of the present application, a computer-readable storage medium (i.e., a non-transitory computer-readable storage medium) is also provided, which stores executable instructions (or program instructions) that, when executed by a processor, implement the self-wake-up control method for a fuel cell system after shutdown as described above.

Additionally, according to yet another aspect of the present application, a computer program product is also provided, comprising a computer program (or instructions), wherein the computer program, when executed by a processor, implements the self-wake-up control method for a fuel cell system after shutdown as described above.

Accordingly, the present application may further provide a computer system, comprising a memory, a processor, and a computer program stored on the memory, wherein the computer program, when executed by the processor, implements the self-wake-up control method for a fuel cell system after shutdown as described above.

The present application has been described in detail in conjunction with specific examples. It is evident, as described above, that the above description and the examples illustrated in the accompanying drawings are to be understood as exemplary and not as limiting the present application. Variations or modifications may be made to the present application by those skilled in the art without departing from the spirit of the present application. Obviously, these variants and modifications do not depart from the scope of the present application.

What is claimed is:

1. A self-wake-up control method for a fuel cell system after shutdown, capable of controlling the self-wake-up process of the fuel cell system of a fuel cell vehicle after shutdown based on remote data acquired from outside the fuel cell vehicle and local data acquired from the fuel cell vehicle, the method comprising:
performing an ambient temperature estimation and confirmation step, wherein, in response to the shutdown of the fuel cell system, remote data related to the driving of the fuel cell vehicle is acquired from outside the fuel cell vehicle, and local data related to the driving of the fuel cell vehicle is acquired from the fuel cell vehicle, and based on the remote data and the local data, the ambient temperature of the fuel cell system is estimated and confirmed; and
performing a self-wake-up process determination step, wherein, based on the confirmed ambient temperature and in combination with data related to the temperature variation of relevant components of the fuel cell system, a corresponding wake-up time interval and wake-up mode are determined.

2. The method according to claim 1, wherein:
the fuel cell vehicle is configured to communicate wirelessly with a cloud platform located outside the fuel cell vehicle, and the remote data is acquired from the cloud platform; and
the relevant components of the fuel cell system include components of the fuel cell system, a coolant circulation pipeline, and a stack, and the data related to the temperature variation of the relevant components of the fuel cell system includes the real-time temperature of the components, the coolant circulation pipeline, and the stack, as well as the time required for them to decrease from different ambient temperatures to a first low-temperature threshold.

3. The method according to claim 2, wherein the wake-up modes comprise:
a mild system wake-up mode, wherein, the temperatures of various sensors in the fuel cell system are acquired and the confirmed ambient temperature for the fuel cell system is updated in real time;
a moderate system wake-up mode, wherein, in addition to the operations performed in the mild system wake-up mode, actuators related to the purging of components of the fuel cell system are also woken up, and the components of the fuel cell system are purged; and
a high-level system wake-up mode, wherein, in addition to the operations performed in the moderate system wake-up mode, the stack of the fuel cell system is started, and the interior of the stack is purged.

4. The method according to claim 3, wherein the fuel cell system is a hydrogen fuel cell system, the hydrogen fuel cell system comprises an anode subsystem, a cathode subsystem, and a thermal management subsystem, the anode subsystem comprises an anode purge valve, the cathode subsystem comprises an air compressor and a backpressure valve, and the thermal management subsystem comprises a pump for pumping coolant; in the moderate system wake-up mode, the process of waking up the actuators related to the purging of components of the fuel cell system includes waking up the air compressor, the backpressure valve, the anode purge valve, and the pump.

5. The method according to claim 2, wherein the ambient temperature estimation and confirmation step comprises:
performing a positioning information acquisition step, wherein, based on the vehicle-mounted cloud control unit of the fuel cell vehicle and big data from the cloud platform, real-time positioning information of the fuel cell vehicle is acquired;
performing a region and time determination step, wherein, based on the real-time positioning information, the current region and current time of the fuel cell vehicle are determined;
performing a temperature acquisition step, wherein the current ambient temperature of the fuel cell system is acquired in real time, the historical minimum temperature of the current region at the same time K years ago stored in the cloud platform is acquired, and the possible minimum temperature of the current region in the next P days predicted by the cloud platform is acquired;
performing a temperature comparison step, wherein the current ambient temperature, the historical minimum temperature, and the possible minimum temperature are compared and the minimum value is taken; and
performing an ambient temperature confirmation step, wherein the minimum value is determined as the confirmed ambient temperature, where K and P are natural numbers greater than or equal to 1, determined based on experiments or experience.

6. The method according to claim 2, wherein the fuel cell system is a hydrogen fuel cell system, the first low-temperature threshold is set to 0° C., and the time required for the components, the coolant circulation pipeline, and the stack to decrease from different ambient temperatures to 0° C. is pre-determined by experiment and the mapping relationship is pre-stored in the cloud platform;
the self-wake-up process determination step comprises:
performing a confirmed temperature comparison and determination step, wherein the confirmed ambient temperature is compared with 0° C. and it is determined whether it is less than 0° C.;
performing a first wake-up time interval determination step and a subsequent first wake-up mode determination step, wherein, in the first wake-up time interval determination step, if the confirmed ambient temperature is determined to be not less than 0° C., the wake-up time interval after the shutdown of the fuel cell system is determined as the first wake-up time interval t based on the mapping relationship stored in the cloud platform, and in the first wake-up mode determination step, the first wake-up mode presented as the mild system wake-up mode is executed; or
performing a second wake-up time interval determination step and a subsequent second wake-up mode determination step, wherein, in the second wake-up time interval determination step, if the confirmed ambient temperature is determined to be less than 0° C., the wake-up time interval is determined as the second wake-up time interval t′ based on the mapping relationship stored in the cloud platform, and in the second wake-up mode determination step, the second wake-up mode presented as the moderate system wake-up mode is executed.

7. The method according to claim 6, wherein, after the first wake-up mode determination step, the self-wake-up control method for a fuel cell system after shutdown further comprises:
performing a system components and coolant circulation pipeline temperature acquisition step, wherein the actual temperature of the components and the actual temperature of the coolant circulation pipeline are acquired, and the lower value of the two is selected;
performing an actual temperature comparison and determination step, wherein the lower value is compared with 0° C. and it is determined whether it is less than 0° C.; and
based on the comparison result between the lower value and 0° C., different wake-up processes are executed.

8. The method according to claim 7, wherein the different wake-up processes comprise:
if the lower value is not less than 0° C., updating the confirmed ambient temperature, comparing it with 0° C. and determining whether it is less than 0° C., returning to the first wake-up time interval determination step if the re-confirmed ambient temperature is not less than 0° C., and proceeding to the second wake-up time interval determination step if the re-confirmed ambient temperature is less than 0° C.; and
if the lower value is less than 0° C., proceeding to the second wake-up mode determination step.

9. The method according to claim 6, wherein after the second wake-up mode determination step, the self-wake-up control method further comprises:
performing a system components and coolant circulation pipeline temperature acquisition step, wherein the actual temperature of the components and the actual temperature of the coolant circulation pipeline are acquired, and the lower value of the two is selected;
performing an actual temperature comparison and determination step, wherein the lower value is compared with 0° C. and it is determined whether it is less than 0° C.; and
based on the comparison result between the lower value and 0° C., different wake-up processes are executed.

10. The method according to claim 9, wherein the different wake-up processes comprise:
if the lower value is not less than 0° C., updating the confirmed ambient temperature and comparing it with 0° C.; if the re-confirmed ambient temperature is not less than 0° C., returning to the first wake-up time interval determination step; if the re-confirmed ambient temperature is less than 0° C., re-determining the wake-up time interval as a third wake-up time interval t″ and then returning to the system components and coolant circulation pipeline temperature acquisition step; and
if the lower value is less than 0° C., updating the confirmed ambient temperature and comparing it with 0° C.; if the re-confirmed ambient temperature is not less than 0° C., re-determining the wake-up time interval as the third wake-up time interval t″ and then returning to the system components and coolant circulation pipeline temperature acquisition step; if the re-confirmed ambient temperature is less than 0° C., acquiring the temperature of the stack, comparing the temperature of the stack with a second low-temperature threshold lower than the first low-temperature threshold, and determining whether it is less than the second low-temperature threshold; if the temperature of the stack is less than the second low-temperature threshold, executing the third wake-up mode presented as the high-level system wake-up mode and then returning to the first wake-up time interval determination step; if the temperature of the stack is not less than the second low-temperature threshold, re-determining the wake-up time interval as a fourth wake-up time interval t″ and then returning to the system components and coolant circulation pipeline temperature acquisition step.

11. The method according to claim 10, wherein, based on the mapping relationship pre-stored in the cloud platform, the time required for the components, the coolant circulation pipeline, and the stack to decrease from different ambient temperatures to 0° C. are respectively represented as tl0, tl1 and tl2, and the first wake-up time interval t, the second wake-up time interval t′, the third wake-up time interval t″, and the fourth wake-up time interval t′″ are respectively determined according to the following formulas:
t=N× tl0, t′=tl0, t″=tl1−tl0, t″=tl2−tl1, where N is a positive integer, and tl0, tl1 and tl2 vary accordingly with variations in ambient temperature.

12. The method according to claim 10, wherein the second low-temperature threshold is in the range of −15° C. to −10° C. and is determined through experiments or experience.

13. A control unit, comprising:
a processor; and
a memory, the memory storing computer programs/instructions, wherein the computer programs/instructions, when executed by the processor, implement the method according to claim 1.

14. A computer program product, comprising a computer program, wherein the computer program, when executed by a processor, implements the method according to claim 1.

15. A computer-readable storage medium, storing executable instructions, wherein the executable instructions, when executed by a processor, implement the method according to claim 1.
